(19) United States
(12) Patent Application Publication
(10) Pub. No.: US 2002/0071208 A1
(43) Pub. Date: Jun. 13, 2002

(54) Perpendicular magnetic recording head to reduce side writing

(76) Inventors: Sharat Batra, Wexford, PA (US); Gregory J. Parker, Warrendale, PA (US)

Correspondence Address: Benjamin T. Queen, II, Pietragallo, Bosick & Gordon, One Oxford Centre, 38th Floor, 301 Grant Street, Pittsburgh, PA, 15219, US

(21) Appl. No.: 09/998,696

(22) Filed: Nov. 30, 2001

Related U.S. Application Data
(60) Provisional application No. 60/254,260, filed on Dec. 8, 2000.

(51) Int. Cl. G11B 5/127

(52) U.S. Cl. 360/125

(57) ABSTRACT

A perpendicular magnetic recording head includes a write pole, a first return pole adjacent an end of the write pole, and a second return pole adjacent an opposing end of the write pole. The perpendicular magnetic recording head also includes a side shield, adjacent a side of the write pole, that extends at least partially between the first return pole and the second return pole to minimize side writing from the recording head. The perpendicular magnetic recording head may also include an additional side shield adjacent an opposing side of the write pole.

### CROSS REFERENCE TO RELATED APPLICATION

This application claims the benefit of U.S. Provisional Application No. 60/254,260 filed Dec. 8, 2000.

### FIELD OF THE INVENTION

The invention relates to magnetic recording heads, and more particularly, relates to a perpendicular magnetic recording head to reduce side writing.

### BACKGROUND OF THE INVENTION

The expectation in the data storage industry is that areal density will increase at a cumulative annual growth rate (CAGR) of greater than 60% and the data rate will increase at a rate greater than 40% for the foreseeable future. Most recording systems use longitudinal recording schemes. The data storage industry has made significant progress in increasing the sensitivity of the reader sensor by advancing anisotropic magnetoresistance (AMR) and giant magnetoresistance (GMR) reader architectures. A noise analysis of a high-end disc drive system indicates that one of the dominant sources of the noise is media noise. To reduce the media noise and have sharper transition, a higher coercivity and lower Mrt (media remanence times media thickness) media is preferred. However, by reducing the Mrt of the media, which reduces the grain volume, the medium may switch its magnetization due to thermal excitations (i.e. superparamagnetic effect). Further, demagnetization fields are higher at higher linear density. This demagnetization field makes the onset of the superparamagnetic effect even faster by decreasing the energy barrier between the two states of magnetization for the grains. Therefore, alternate technologies such as perpendicular recording have been developed to maintain the expected increase in areal density.

Perpendicular recording designs have the potential to support much higher linear densities than conventional longitudinal designs due to a reduced demagnetizing field in the recording transitions. Perpendicular recording also offers an advantage because the transition width is defined by the gradient of the head field. Because of near perfect orientation of the perpendicular media, and the fact that the demagnetization field is lowered when transitions are brought closer together, perpendicular media provides less noise than longitudinal recording. Further, a relatively thicker media for perpendicular recording compared to longitudinal media can be used, which may improve the thermal stability. Thus, the preferred approach to perpendicular recording requires use of the soft underlayer media. The soft underlayer helps with sharp field gradient and also strong fields to be able to write on a high coercive media.

A conventional perpendicular recording head, illustrated in FIG. 1, includes a main or trailing write pole 11, a return or opposing pole 13 magnetically coupled to the write pole 11, and an electrically conductive magnetizing coil 15 surrounding the write pole 11. A perpendicular recording medium 17 may include a hard magnetic recording layer 19 with vertically oriented magnetic domains 21 and a soft magnetic underlayer 23 to enhance the recording head fields and provide a flux path 25 from the trailing write pole 11 to the return pole of the writer. Such perpendicular recording media may also include a thin interlayer between the hard recording layer and the soft underlayer to prevent exchange coupling between the hard and soft layers.

To write to the magnetic recording medium 17, the recording head is separated from the magnetic recording medium by a distance known as the flying height. The magnetic recording medium 17 is moved past the recording head so that the recording head follows the tracks of the magnetic recording medium 17, with the magnetic recording medium 17 first passing under the return pole 13 and then passing under the write pole 11. Current is passed through the coil 15 to create magnetic flux within the write pole 11. The magnetic flux 25 passes from the tip of the write pole 11, through the hard magnetic recording layer 19, into the soft underlayer 23, and across to the return pole 13.

In addition, the soft underlayer 23 helps during the read operation. During the read back process, the soft underlayer 23 produces the image of magnetic charges in the magnetically hard layer 19, effectively increasing the magnetic flux coming from the medium 17. This provides a higher playback signal.

Using a conventional perpendicular recording head, such as shown in FIG. 1, with a return path will provide sharp transitions. However, the extent of side writing with the conventional perpendicular recording head design is a problem with such designs. Side writing is a problem whereby the process of writing bits to the recording medium, such as the recording medium 17, additionally creates a magnetic field adjacent to the bits but outside of the track in which the writing process is taking place. Therefore, if tracks are placed too near to one another, these magnetic fields created by the side writing phenomenon may corrupt the bits on adjacent tracks. Therefore, perpendicular recording heads that reduce or minimize side writing are desirable.

There is identified, therefore, a need for a perpendicular magnetic recording head that overcomes limitations, disadvantages, or shortcomings of known magnetic recording heads and reduces or minimizes side writing.

### SUMMARY OF THE INVENTION

The invention meets the identified need, as well as other needs, as will be more filly understood following a review of this specification and drawings.

In accordance with an aspect of the invention, a perpendicular magnetic recording head comprises a main write pole, a first return pole adjacent an end of the write pole, a second return pole adjacent an opposing end of the write pole, and a side shield adjacent a side of the write pole and extending at least partially between the first return pole and the second return pole. The perpendicular magnetic recording head may also include an additional side shield adjacent an opposing side of the write pole and extending at least partially between the first return pole and the second return pole. The side shield and the additional side shield advantageously reduce or minimize side writing in tracks adjacent to a track of a magnetic recording medium upon which a write operation is being performed.

In accordance with an additional aspect of the invention, a perpendicular recording head, for use with a magnetic recording medium having a plurality of magnetic tracks, comprises a write pole, a first return pole adjacent an end of the write pole, a second write pole adjacent an opposing end of the write pole and means for shielding opposing sides of the write pole to minimize or reduce side writing in tracks adjacent to the track in which a write operation is being performed.

In accordance with a further aspect of the invention, a magnetic disc drive storage system comprises a housing, a perpendicular magnetic recording medium positioned in the housing and a perpendicular magnetic recording head positioned in the housing adjacent the perpendicular magnetic recording medium. The perpendicular magnetic recording head comprises a main write pole, a first return pole adjacent an end of the write pole, a second return pole adjacent an opposing end of the write pole, and a side shield adjacent a side of the write pole and extending at least partially between the first return pole and the second return pole. The perpendicular magnetic recording head may also include an additional side shield adjacent an opposing side of the write pole and extending at least partially between the first return pole and the second return pole. The side shield and the additional side shield advantageously reduce or minimize side writing in tracks adjacent to a track of a magnetic recording medium upon which a write operation is being performed.

### BRIEF DESCRIPTION OF THE DRAWINGS

FIG. 1 is a partial side view of a conventional perpendicular magnetic recording head.

FIG. 2 is a pictorial representation of a magnetic disc drive system of the invention.

FIG. 3 is a partial side view of a perpendicular magnetic recording head of the invention.

FIG. 4 is an air bearing surface view of the recording head shown in FIG. 3.

FIG. 5 is a partial isometric view of the recording head shown in FIGS. 3 and 4.

FIG. 6 is a cross track field profile comparing the conventional recording head, such as shown in FIG. 1, with the recording head of the invention shown in FIGS. 3, 4 and 5.

FIG. 7 is a downtrack field profile comparing the conventional recording head, such as shown in FIG. 1, with the recording head of the invention shown in FIGS. 3, 4 and 5.

### DETAILED DESCRIPTION OF THE INVENTION

The invention provides a perpendicular magnetic recording head to reduce side writing. The invention is particularly suitable for use with a magnetic disc storage system. A recording head, as used herein, is defined as a head capable of performing read and/or write operations.

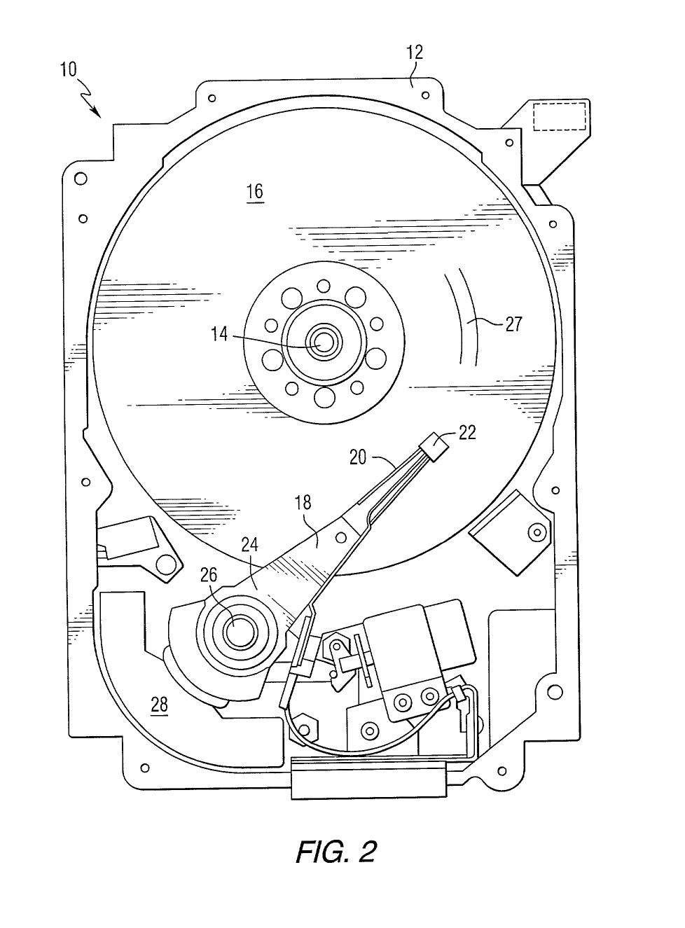

FIG. 2 is a pictorial representation of a disc drive 10 that can utilize a perpendicular magnetic recording head in accordance with this invention. The disc drive 10 includes a housing 12 (with the upper portion removed and the lower portion visible in this view) sized and configured to contain the various components of the disc drive. The disc drive 10 includes a spindle motor 14 for rotating at least one magnetic storage medium 16, which may be a perpendicular magnetic recording medium, within the housing, in this case a magnetic disc. At least one arm 18 is contained within the housing 12, with each arm 18 having a first end 20 with a recording head or slider 22, and a second end 24 pivotally mounted on a shaft by a bearing 26. An actuator motor 28 is located at the arm's second end 24 for pivoting the arm 18 to position the recording head 22 over a desired sector or track 27 of the disc 16. The actuator motor 28 is regulated by a controller, which is not shown in this view and is well known in the art.

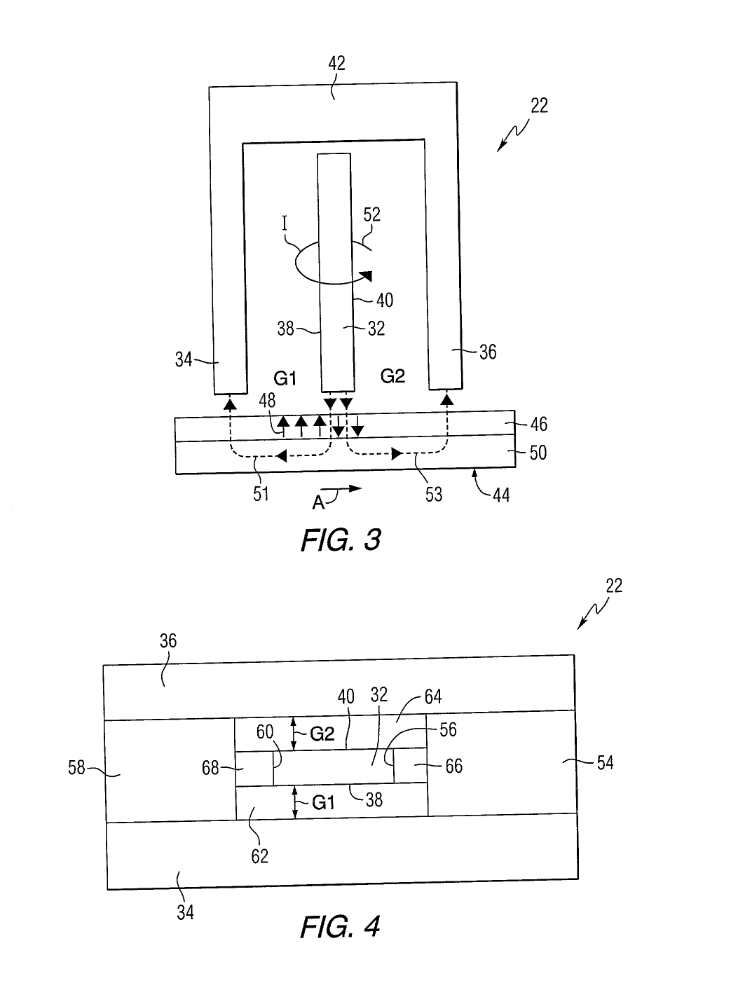

FIG. 3 is a partial side view of a perpendicular magnetic recording head 22 constructed in accordance with this invention. The recording head 22 includes a write pole 32, a first return pole 34 and a second return pole 36. The first return pole 34 is positioned adjacent an end 38 of the write pole 32 and the second return pole 36 is positioned adjacent an opposing end 40 of the write pole 32. The first return pole 34 and the second return pole 36 may be connected by a yoke 42. The first and second return poles 34 and 36 may be positioned along a down track direction. Advantageously, the arrangement of a first and second return pole 34 and 36 reduces the magnetic field or the concentration of magnetic flux under the return poles 34 and 36 because of the additional magnetic flux path.

FIG. 3 also illustrates a perpendicular magnetic recording medium 16 upon which the recording head 22 may perform a write operation. The recording medium 16 may include a hard magnetic recording layer 46 with vertically oriented magnetic domains 48 and a soft magnetic underlayer 50 to enhance the recording head fields and provide a flux path from the write pole 32 to the first return pole 34 and the second return pole 36. In operation of the recording head 22 to write to the magnetic recording medium 16, the recording medium 16 passes beneath the recording head 22 in the direction indicated by arrow A. A current I is passed through an electrically conductive magnetizing coil 52 to create magnetic flux within the write pole 32. The magnetic flux passes from a tip of the write pole 32 through the hard magnetic recording layer 46 and into the soft underlayer 50. The magnetic flux from the write pole 32 then disperses in different directions with a portion of the magnetic flux 51 passing to the first return pole 34, through a pole tip thereof, and an additional portion of the magnetic flux 53 passing to the second return pole 36, through a pole tip thereof

As best shown in FIGS. 4 and 5, the recording head 22 also includes a side shield 54 adjacent a side 56 of the write pole 32. The side shield 54 extends at least partially between the first return pole 34 and the second return pole 36 and, as illustrated, the side shield 54 may be in contact with or connected to the first return pole 34 and/or the second return pole 36. In addition, the recording head 22 may also include an additional side shield 58 adjacent an opposing side 60 of the write pole 32. The additional side shield 58 also extends at least partially between the first return pole 34 and the second return pole 36. The side shields 54 and 58 may be positioned along a cross track direction.

In accordance with the invention, the side shields 54 and 58 advantageously combine with the first return pole 34 and the second return pole 36 to enclose, at least partially, the main write pole 32. More specifically, the side shields 54 and 58 along with the first return pole 34 and the second return pole 36 at least partially, if not entirely as shown in FIG. 4, surround the write pole 32 at an air-bearing surface level of the recording head 22 to reduce or minimize the extent of side writing that may occur during a write operation being performed by the recording head 22 to the recording medium 16. By reducing side writing, the track density for the recording medium 16, and, therefore, areal density is improved

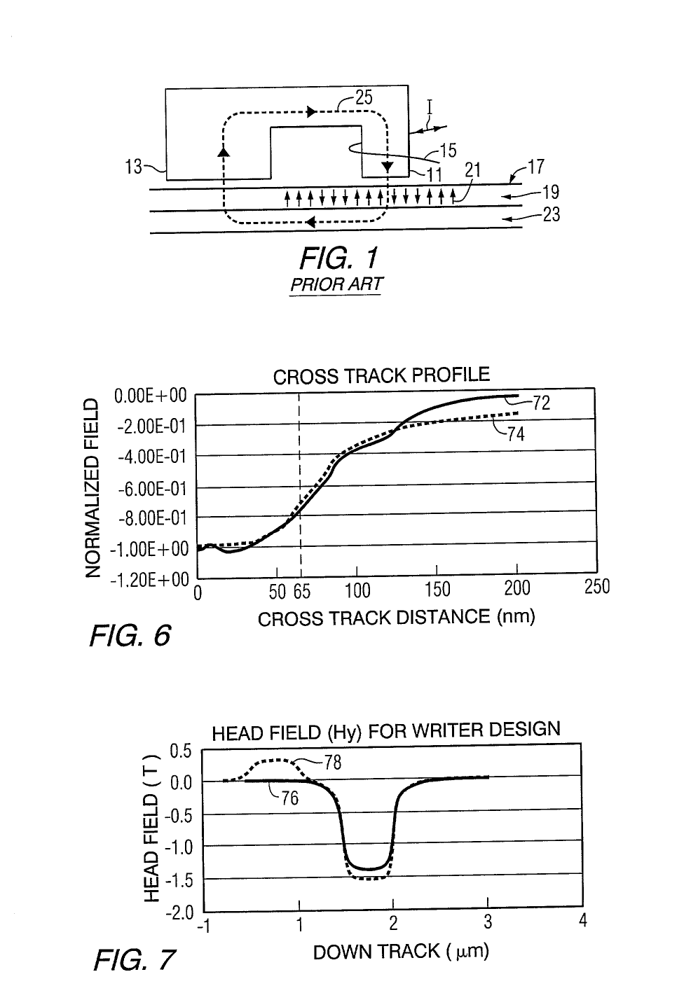

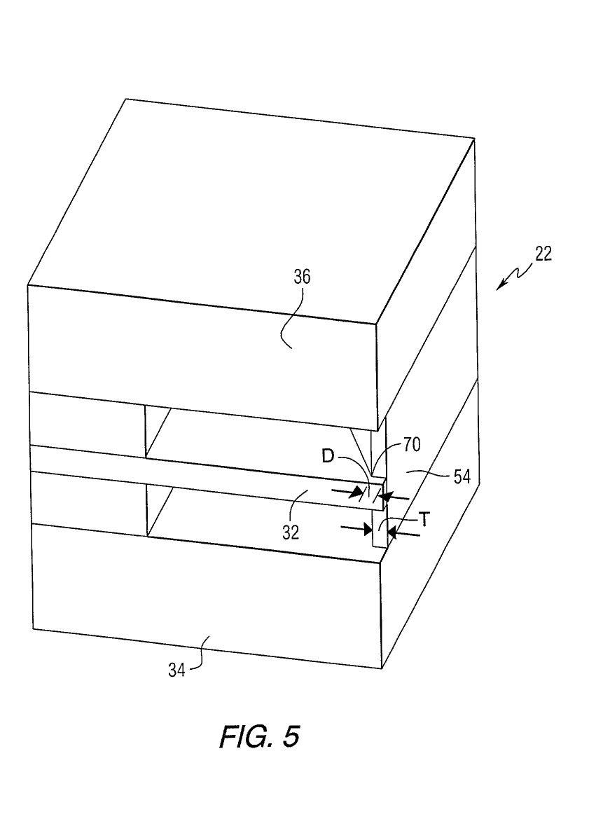

FIG. 6 illustrates an example of how the recording head 22 with side shields 54 and 58 may reduce or minimize side writing in comparison to a conventional perpendicular magnetic recording head, such as illustrated in FIG. 1. Specifically, the results set forth in FIG. 6 illustrates the cross track profile for a write operation at the recording medium, wherein the recording head has a physical track width of 130 nm, with only one-half of the track width, e.g. 65 nm, illustrated in FIG. 6 to show the amount of side writing that takes place beyond the 65 nm track boundary. As shown, the amount of side writing is shown to be reduced for the recording head 22 as the strength of the normalized field more rapidly approaches zero (as represented by line 72) than did the field for the conventional perpendicular magnetic recording head (as represented by line 74). While the side shields 54 and 58 provide additional flux paths, this arrangement may result in some flux leakage that may decrease the overall efficiency of the recording head 22. However, any such decreases in efficiency may be made up by, for example, increasing current flow I through the magnetizing coil 52.

Referring to FIGS. 3 and 4, the tip of the write pole 32 and the tip of the first return pole 34 are spaced apart to define a first write gap G1 therebetween. Similarly, the tip of the write pole 32 and the second return pole 36 are spaced apart to define a second write gap G2 therebetween. The first write gap G1 may have a distance of from about 50 nm to about 1000 nm. The second write gap G2 may have a distance of from about 50 nm to about 1000 nm.

As best shown in FIG. 4, the space between the write pole 32 and the first return pole 34 is filled, above the write gap G1, by a non-magnetic insulative material 62. Similarly, the space between the write pole 32 and the second return pole 36 above the write gap G2 is filled by a non-magnetic insulative material 64. A non-magnetic insulative material 66 may be placed between the side shield 54 and the side 56 of the write pole 32 and a non-magnetic insulative material 68 may be placed between the opposing side 60 of the write pole 32 and the side shield 58. The distance separating the write pole 32 and the side shields 54 and 58 is preferably 2-10 times the distance that separates the air bearing surface of the write pole 32 and the soft underlayer 50 of the recording medium 16, such distance between the write pole 32 and the soft underlayer 50 being from about 5 nm to about 60 nm.

In order to facilitate the writing process from the recording head 22 to the recording medium 16, the first return pole 34 and the second return pole 36 each have a surface area at the air-bearing surface thereof larger than a surface area of the write pole 32 at the air-bearing surface thereof. Similarly, the side shields 54 and 58 may each have a surface area at the air-bearing surface thereof larger than a surface area of the write pole 32 at the air-bearing surface thereof.

The first return pole 34 and the second return pole 36 may comprise at least one material selected from the group consisting of soft magnetic materials such as Co, Fe or Ni. In addition, the side shields 54 and 58 may comprise at least one material selected from the group consisting of soft magnetic materials such as Co, Fe or Ni.

Referring to FIG. 5, the side shield 54 may have a thickness T equal to or lesser than a breakpoint dimension D of the write pole 32. The breakpoint of the write pole 32 is the place where the write pole 32 starts to widen, as shown at 70. The thickness T of the side shield 54 may be from about 50 nm to about 500 nm. A thickness of the additional side shield 58 may also be equal to or lesser than the breakpoint dimension of the write pole 32, or have a thickness of 50 nm to about 500 nm.

In addition to the recording head 22 minimizing or reducing the amount of side writing that may occur during a write operation, an additional advantage of the invention is that the magnetic field under the first return pole 34 and second return pole 36 is significantly reduced by providing an additional flux path. As illustrated in FIG. 7, this will have the advantage of generating large magnetic fields under the write pole 32 without the magnetic fields under the return poles 34 and 36 erasing or corrupting data on adjacent tracks. FIG. 7 compares the down track field profile (H_{y}) for the perpendicular magnetic recording head 22 of the invention (as represented by line 76) and a conventional perpendicular magnetic recording head (as represented by line 78), such as shown in FIG. 1.

An additional advantage of the invention is reducing the effect of stray fields. For example, in a conventional two pole perpendicular magnetic recording head, such as shown in FIG. 1, any stray field normal to the write pole will be amplified at the air-bearing surface by the ratio of the widths of the yoke to the track width. This field can be substantial, for example, a 10 Oe stray field and a return pole yoke width of 10 um and a track width of 0.1 um, the magnetic field at the air-bearing surface will be 1000 Oe. This additional field may effect 30 writing and may corrupt the written transitions during a read back operation. However, the perpendicular magnetic recording head 22 of the invention, which includes the side shields 54 and 58, shields the write pole 32 from the stray field, thereby minimizing the effect of the stray field. In other words, the configuration of the perpendicular magnetic recording head 22 having a first return pole 34, second return pole 36, and side shields 54 and 58 extending therebetween acts as an umbrella for shielding the write pole 32 and reducing the effect of stray magnetic fields.

The perpendicular magnetic recording head 22 may be built using conventional read and write head processes. The recording head 22 may use a solenoid coil with one or more multiple turns around the write pole 32. The recording head 22 could also use a single turn microstrip wave-guide configuration where a ground plane is formed under the write and signal plane above the write pole 32 or vice versa.

The recording head 32 may be built using conventional read and write head forming processes. This head design may use a solenoid coil with one or multiple turns around the center write pole. This geometry could use the single turn wave-guide in micro-strip configuration, i.e. where the ground plane is formed under the write and signal plane above the write pole or vice versa.

One method of processing this structure may use a first return or bottom pole, and developing a pattern (either sputtered or plated) for the back pedestal and front magnetic pedestal. A first trace of Cu coil is defined in between the front and back pedestal using a self-aligned or an alternate process. The method may also include a chemical mechanical planarization (CMP) process that exposes the front and back magnetic pedestal and patterning of the main write pole with side shields. A non-magnetic seed layer may be used to pattern the main write pole with shorted side shields. A CMP process may be used to expose the main write pole and control its thickness. An additional non-magnetic insulator may be deposited on top of the main write pole. The method may also include patterning the second trace of coil. Standard processing techniques for connecting the two traces of Cu coil to fabricate a solenoidal coil may be used. The method may further include deposition and planarization of another insulator layer. Finally, second return pole may be plated or sputtered deposited. Standard processing techniques for connecting the second return pole to the side shield may be used.

Whereas particular embodiments of the invention have been described herein for the purpose of illustrating the invention and not for purpose of limiting the same, it will be appreciated by those of ordinary skill in the art that numerous variations of the details, materials, and arrangements of parts may be made within the principle and scope of the invention without departing from the invention as described herein and in the appended claims.

What is claimed is:

1. A perpendicular magnetic recording head, comprising:
a write pole;
a first return pole adjacent an end of said write pole;
a second return pole adjacent an opposing end of said write pole; and
a side shield adjacent a side of said write pole and extending at least partially between said first return pole and said second return pole.

2. The perpendicular magnetic recording head of claim 1, wherein said write pole includes a write pole tip and said first return pole includes a first return pole tip, said write pole tip and said first return pole tip spaced apart to define a first write gap therebetween.

3. The perpendicular magnetic recording head of claim 2, further including a non-magnetic insulative material between said write pole and said first return pole.

4. The perpendicular magnetic recording head of claim 2, wherein said first write gap has a distance of from about 50 nm to about 1000 nm.

5. The perpendicular magnetic recording head of claim 1, wherein said write pole includes a write pole tip and said second return pole includes a second return pole tip, said write pole tip and said second return pole tip spaced apart to define a second write gap therebetween.

6. The perpendicular magnetic recording head of claim 5, further including a non-magnetic insulative material between said write pole and said second return pole.

7. The perpendicular magnetic recording head of claim 5, wherein said second write gap has a distance of from about 50 nm to about 1000 nm.

8. The perpendicular magnetic recording head of claim 1, wherein said side shield has a thickness equal to or lesser than a breakpoint dimension of said write pole.

9. The perpendicular magnetic recording head of claim 1, further including an insulative material between a side of said write pole and said side shield.

10. The perpendicular magnetic recording head of claim 1, wherein said first return pole and second return pole each comprise at least one material from the group consisting of soft magnetic materials containing at least one of Co, Fe or Ni.

11. The perpendicular magnetic recording head of claim 1, wherein said side shield comprises at least one material selected from the group consisting of soft magnetic materials containing at least one of Co, Fe or Ni.

12. The perpendicular magnetic recording head of claim 1, wherein said first return pole and said second return pole each have a surface area at an air-bearing surface thereof larger than a surface area of said write pole at an air-bearing surface thereof.

13. The perpendicular magnetic recording head of claim 1, further including an additional side shield adjacent an opposing side of said write pole and extending at least partially between said first return pole and said second return pole.

14. The perpendicular magnetic recording head of claim 13, wherein said additional side shield has a thickness equal to or lesser than a breakpoint dimension of said write pole.

15. The perpendicular magnetic recording head of claim 13, further including a non-magnetic insulative material between said opposing side of said write pole and said additional side shield.

16. The perpendicular magnetic recording head of claim 13, wherein said additional side shield comprises at least one material selected from the group consisting of soft magnetic materials containing at least one of Co, Fe or Ni.

17. The perpendicular magnetic recording head of claim 13, wherein said first return pole, said second return pole, said side shield and said additional side shield substantially surround said write pole at an air-bearing surface of the perpendicular magnetic recording head.

18. A perpendicular magnetic recording head for use with a magnetic recording medium having a plurality of magnetic tracks, the perpendicular magnetic recording head comprising:
a write pole;
a first return pole adjacent an end of said write pole;
a second return pole adjacent an opposing end of said write pole; and
means for shielding opposing sides of said write pole to minimize side writing in magnetic tracks adjacent to the magnetic track in which a write operation is being performed.

19. A magnetic disc drive storage system, comprising:
a housing;
a perpendicular magnetic recording medium positioned in said housing; and
a perpendicular magnetic recording head mounted in said housing adjacent said perpendicular magnetic recording medium, wherein said perpendicular magnetic recording head comprises:
a write pole;
a first return pole adjacent an end of said write pole;
a second return pole adjacent an opposing end of said write pole; and
a side shield adjacent a side of said write pole and extending at least partially between said first return pole and said second return pole.

20. The magnetic disc drive storage system of claim 19, further including an additional side shield adjacent an opposing side of said write pole and extending at least partially between said first return pole and said second return pole.
